(19) United States
(12) Patent Application Publication
(10) Pub. No.: US 2026/0045676 A1
(43) Pub. Date: Feb. 12, 2026

(54) Wind disturbance compensation control methods, system, device and media for large-diameter reflective antennas

(71) Applicant: Northwest China Research Institute of Electronic Equipment (NWIEE), Xi'an (CN)

(72) Inventors: Dongwei LI, Xi'an (CN); Bo LIU, Xi'an (CN); Wulin ZHAO, Xi'an (CN); Hongwei LI, Xi'an (CN); Gengxin HE, Xi'an (CN); Danhua LUO, Xi'an (CN); Jin HOU, Xi'an (CN); Wei ZHANG, Xi'an (CN); Rongxia DONG, Xi'an (CN)

(73) Assignee: Northwest China Research Institute of Electronic Equipment (NWIEE), Xi'an, SN (CN)

(21) Appl. No.: 19/360,975

(22) Filed: Oct. 16, 2025

(30) Foreign Application Priority Data
Oct. 18, 2024 (CN) 202411455248.7

(51) Int. Cl. H01Q 1/00; H01Q 19/10

(52) U.S. Cl. CPC H01Q 1/005; H01Q 19/10

(57) ABSTRACT

The present invention relates to the field of antenna control technology, and discloses a large-diameter reflective surface antenna wind disturbance compensation control method, system, equipment and medium. The method consists of obtaining the optimal gain for wind disturbance compensation of large-diameter reflector antennas through a Kalman filter. The optimal gain is input into a trained error prediction model, and it is converted into a two-dimensional matrix to mine the correlation features between adjacent elements in different directions of the two-dimensional matrix and the correlation features between non-adjacent elements in different directions. The optimal gain obtained by the Kalman filter is optimized via correlation features between adjacent elements in different directions of the two-dimensional matrix and correlation features between non-adjacent elements. The wind disturbance compensation effect of the large-diameter reflector antenna can be improved by using the optimized optimal gain to compensate for wind disturbance of the large-diameter reflector antenna.

### TECHNICAL FIELD

The present invention relates to the field of antenna control technology, and in particular to a method, system, device and medium for controlling wind disturbance compensation of a large-aperture reflector antenna.

### BACKGROUND

Large-aperture reflector antennas are key devices in radio astronomy and deep space exploration. Stable, high-precision pointing is a fundamental prerequisite for high-quality missions. Gusts of wind during mission operations can cause severe interference to the antennas, necessitating the design of reasonable methods for wind disturbance control and compensation.

The impact of wind disturbances can be reduced by establishing a reasonable wind disturbance control model. Currently, the linear quadratic Gaussian (LOG) control method is commonly used. Based on incomplete state measurements, the system's various states are estimated, and the gain due to wind disturbances is derived, thereby achieving optimal control. As shown in FIG. 1, the controlled object is a large-aperture reflector antenna. Various parameters of the controlled object are input into a Kalman filter, which is used to determine the optimal gain of the controlled object. This optimal gain is then used to compensate for wind disturbances in the large-aperture reflector antenna.

However, the Kalman filter is not very effective in scenarios where external factors vary greatly, resulting in poor wind disturbance control compensation.

### SUMMARY

The object of the present invention is to provide a method, system, device and medium for controlling wind disturbance compensation of a large-aperture reflector antenna, which can realize optimal wind disturbance compensation control of the large-aperture reflector antenna.

To solve the above technical problems, an embodiment of the present invention provides a method for controlling wind disturbance compensation of a large-aperture reflector antenna, comprising the following steps:
the large-aperture reflector antenna are input into the Kalman filter, and the state of the large-aperture reflector antenna is estimated by the Kalman filter to obtain the optimal gain for wind disturbance compensation of the large-aperture reflector antenna;
Inputting the optimal gain into a trained error prediction model, wherein the error prediction model includes a data conversion module, a cross scan module, and a dilated convolution module;
The data conversion module extracts feature information from the optimal gain, stores the feature information in a one-dimensional vector, and converts the one-dimensional vector into a two-dimensional matrix using a preset projection matrix. The cross scan module mines the correlation features between adjacent elements in different directions of the two-dimensional matrix, and the dilated convolution module mines the correlation features between non-adjacent elements in different directions of the two-dimensional matrix.

The optimal gain obtained by the Kalman filter is optimized through the correlation characteristics between adjacent elements in different directions of the two-dimensional matrix and the correlation characteristics between non-adjacent elements;
The optimized optimal gain is used to compensate for wind disturbance of large-aperture reflector antenna.

In some optional embodiments, mining association features between adjacent elements in different directions of the two-dimensional matrix by the cross scan module includes:

The cross scan module is used to scan the two-dimensional matrix horizontally, vertically, anti-horizontally and anti-vertically respectively. During the horizontal, vertical, anti-horizontally and anti-vertical scanning processes, the association relationship between each element in the two-dimensional matrix and the adjacent elements in different directions is extracted, and the association features between the adjacent elements in different directions of the two-dimensional matrix are obtained.

In some optional embodiments, the dilated convolution module is composed of dilated convolution operators of different scales, and mining the correlation features between non-adjacent elements in different directions of the two-dimensional matrix through the dilated convolution module includes:
During the cross scan module's horizontal, vertical, anti-horizontal, and anti-vertical scanning of a two-dimensional matrix, dilated convolution operators of different scales in the dilated convolution module are used to increase the step size of the cross scan module's scanning, so as to extract the association relationship between each element in the two-dimensional matrix and non-adjacent elements in different directions, and obtain the association features between non-adjacent elements in different directions of the two-dimensional matrix.

In some optional embodiments, the error prediction model further includes a fully connected layer, and optimizing the optimal gain of the Kalman filter output by using the correlation features between adjacent elements in different directions of the two-dimensional matrix and the correlation features between non-adjacent elements includes:
The fully connected layer outputs the correction amount corresponding to the optimal gain based on the correlation features between adjacent elements in different directions of the two-dimensional matrix and the correlation features between non-adjacent elements;
The correction amount output by the error prediction model is added to the optimal gain to obtain the optimized optimal gain.

In some optional embodiments, the error prediction model is trained in the following manner:
Obtain the optimal gain obtained by the Kalman filter as sample data;
to the sample data, and the error prediction model is trained using the sample data after adding the noise. During the training process, the intensity of the Gaussian noise is gradually increased so that the error prediction model is trained using sample data with different noise intensities.

In some optional embodiments, the state parameters of the large-aperture reflector antenna include:
The speed output command of the large-aperture reflector antenna, the current azimuth angle, pitch angle, antenna pointing deviation, equivalent force area, and the wind speed, wind direction, temperature, humidity, and air pressure of the large-aperture reflector antenna's environment.

In some optional embodiments, the optimal gain includes the difference between the state prediction value and the state estimation value, the difference between the observation value and the estimated observation value, and the filtering gain of the Kalman filter for the large-aperture reflector antenna.

An embodiment of the present invention further provides a large-aperture reflector antenna wind disturbance compensation control system, comprising:
A gain acquisition module is used to input the state parameters of the large-aperture reflector antenna into a Kalman filter, perform state estimation on the large-aperture reflector antenna through the Kalman filter, and obtain the optimal gain for wind disturbance compensation of the large-aperture reflector antenna;
A model solving module, configured to input the optimal gain into a trained error prediction model, wherein the error prediction model includes a data conversion module, a cross scan module, and a dilated convolution module;
The data conversion module extracts feature information from the optimal gain, stores the feature information in a one-dimensional vector, and converts the one-dimensional vector into a two-dimensional matrix using a preset projection matrix. The cross scan module mines the correlation features between adjacent elements in different directions of the two-dimensional matrix, and the dilated convolution module mines the correlation features between non-adjacent elements in different directions of the two-dimensional matrix.

A gain optimization module is used to optimize the optimal gain obtained by the Kalman filter through the correlation characteristics between adjacent elements in different directions of the two-dimensional matrix and the correlation characteristics between non-adjacent elements;
of the large-aperture reflector antenna using the optimized optimal gain.

An embodiment of the present invention also provides a computer device, comprising: at least one processor; and a memory communicatively connected to the at least one processor; wherein the memory stores instructions executable by the at least one processor, and the instructions are executed by the at least one processor so that the at least one processor can execute the above-mentioned large-aperture reflector antenna wind disturbance compensation control method.

An embodiment of the present invention further provides a computer-readable storage medium storing a computer program, which implements the above-mentioned large-aperture reflector antenna wind disturbance compensation control method when executed by a processor.

The wind disturbance compensation control method for a large-aperture reflector antenna provided by the present invention has at least the following beneficial effects:
First, the optimal gain estimated by the Kalman filter for wind disturbance compensation of large-aperture reflector antennas is obtained, that is, the output of the Kalman filter in traditional technology. This gain is used as the model input data and processed using a trained error prediction model. After converting it into a two-dimensional matrix, deep fusion and extraction of the input data can be achieved by mining the correlation features between adjacent elements in different directions of the two-dimensional matrix, as well as the correlation features between non-adjacent elements in different directions of the two-dimensional matrix. Based on this, the output of the traditional Kalman filter is optimized, which can achieve a more accurate estimation of the antenna state and achieve the goal of improving the accuracy of antenna wind disturbance compensation. Furthermore, under the influence of complex external factors, the antenna position can be better adjusted to the correct position.

### BRIEF DESCRIPTION OF THE DRAWINGS

One or more embodiments are exemplarily described by the figures in the corresponding drawings, and these exemplified descriptions do not constitute limitations on the embodiments.

FIG. 1 is a schematic diagram of wind disturbance compensation control of an antenna;

FIG. 2 is a flow chart of a method for controlling wind disturbance compensation of a large-aperture reflector antenna according to an embodiment of the present invention;

FIG. 3 is a schematic diagram 1 of a network structure provided according to an embodiment of the present invention;

FIG. 4 is a schematic diagram of a wind disturbance compensation control method for a large-aperture reflector antenna according to an embodiment of the present invention;

FIG. 5 is a schematic diagram of a denoising process of a diffusion model according to an embodiment of the present invention;

FIG. 6 is a second schematic diagram of a network structure provided according to an embodiment of the present invention;

FIG. 7 is a schematic diagram of a wind disturbance compensation control system for a large-aperture reflector antenna according to an embodiment of the present invention;

FIG. 8 is a schematic structural diagram of a computer device according to an embodiment of the present invention.

### DETAILED DESCRIPTION OF EMBODIMENTS

In order to make the purpose, technical solution and advantages of the embodiments of the present invention clearer, each embodiment of the present invention will be elaborated in detail in combination with the attached drawings below. However, it will be understood by those skilled in the art that in the embodiments of the present invention, many technical details are provided to enable the reader to better understand the present invention. However, even without these technical details and the various changes and modifications based on the following embodiments, the technical solutions claimed in the present invention can be implemented. The division of the following embodiments is for convenience of description and should not constitute any limitation on the specific implementation of the present invention. The various embodiments can be combined with each other and referenced to each other under the premise that there is no contradiction.

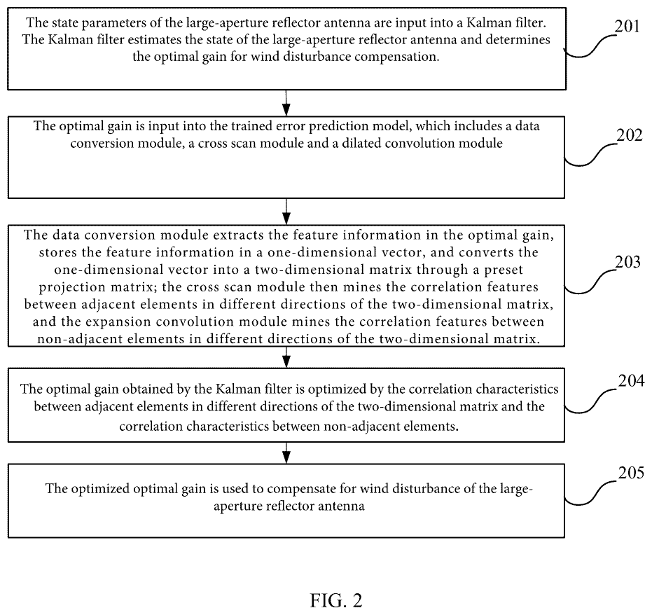

One embodiment of the present invention relates to a method for controlling wind disturbance compensation for a large-aperture reflector antenna. The specific process of the method for controlling wind disturbance compensation for a large-aperture reflector antenna of this embodiment may be shown in FIG. 2, including:

Step 201: input the state parameters of the large-aperture reflector antenna into a Kalman filter, perform state estimation on the large-aperture reflector antenna through the Kalman filter, and obtain an optimal gain for wind disturbance compensation of the large-aperture reflector antenna.

Step 202: Input the optimal gain into the trained error prediction model, where the error prediction model includes a data conversion module, a cross scan module, and a dilated convolution module.

In step 203, feature information in the optimal gain is extracted through a data conversion module, the feature information is stored in a one-dimensional vector, and the one-dimensional vector is converted into a two-dimensional matrix through a preset projection matrix; the correlation features between adjacent elements in different directions of the two-dimensional matrix are mined through a cross scan module, and the correlation features between non-adjacent elements in different directions of the two-dimensional matrix are mined through a dilated convolution module.

Step 204: Optimizing the optimal gain obtained by the Kalman filter through the correlation features between adjacent elements in different directions of the two-dimensional matrix and the correlation features between non-adjacent elements.

Step 205: Use the optimized optimal gain to perform wind disturbance compensation on the large-aperture reflector antenna.

In this embodiment, the optimal gain for wind disturbance compensation of a large-aperture reflector antenna estimated by the Kalman filter, that is, the output of the Kalman filter in traditional technology, is obtained and used as model input data. It is processed using a trained error prediction model and converted into a two-dimensional matrix. By mining the correlation features between adjacent elements in different directions of the two-dimensional matrix and the correlation features between non-adjacent elements in different directions of the two-dimensional matrix, deep fusion extraction of the input data can be achieved. Based on this, the output of the traditional Kalman filter is optimized, and a more accurate estimation of the antenna state can be achieved, thereby achieving the goal of improving the accuracy of antenna wind disturbance compensation. Furthermore, under the influence of complex external factors, the position of the antenna can be better adjusted to the correct position through adjustment.

describes in detail the implementation of the wind disturbance compensation control method for a large-aperture reflector antenna in accordance with this embodiment. The following content is merely provided for ease of understanding and is not essential for implementing this solution.

First of all, it should be noted that the antennas mentioned below all refer to large-aperture reflector antennas.

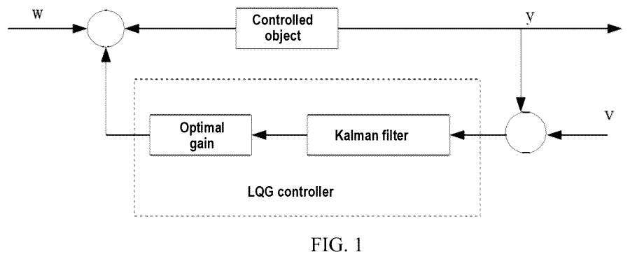

In step 201, the impact of wind disturbance on antenna pointing can be mainly divided into two parts based on the disturbance mechanism: one part is the axis angle error caused by the interference torque acting on the antenna shaft, and the other part is the pointing error caused by the wind pressure acting on the reflective surface, which causes the antenna structure to be deformed. Therefore, it is very necessary to establish a reasonable wind disturbance control model to reduce the impact of wind disturbance. For example, see the traditional wind disturbance control model shown in FIG. 1. This model is actually an output feedback control problem, which is a comprehensive control of linear quadratic regulator (LQR) control and Kalman filter based on state feedback. This embodiment actually obtains the optimal gain for wind disturbance compensation of large-aperture reflective antennas, estimated by the Kalman filter, that is, the output of the Kalman filter shown in FIG. 1.

First, to introduce the working principle of the Kalman filter:

The state equation of the Kalman filter is:

$${x}_{k} = A {x}_{k - 1} + B {u}_{k - 1} + {w}_{k - 1} ;$$

where xₖ represents the state vector of the target, A represents the state transition matrix, B represents the control matrix that converts the input into state, uₖ₋₁ represents the control vector, and wₖ₋₁ represents the predicted noise, which follows the Gaussian distribution.

The observation equation is:

$${z}_{k} = H {x}_{k} + {v}_{k} ;$$

where zₖ represents the observation vector of the target, and vₖ is the observed noise, which obeys a Gaussian distribution.

The implementation of the Kalman filter is divided into two steps: prediction and update. Prediction involves estimating the state at the current time, k based on the posterior estimate at the previous time, k−1, yielding an a priori estimate of the moment k. Updates involve correcting the estimate from the prediction phase using the current measurement, yielding a posterior estimate for the current moment. The following time update equation (i.e., the prediction phase) is used to infer the current prior estimates of the state variables and the error covariance from the previous state estimate. The state update equation (i.e., the update phase) combines the prior estimates with the new measurement variables to construct an improved posterior estimate.

the time update equation is:

$${\hat{x}}_{\overline{k}} = A {\hat{x}}_{k - 1} + B {u}_{k - 1} ;$$

$${P}_{\overline{k}} = A {P}_{k - 1} {A}^{T} + Q ;$$

wherein \hat{x}ₖ₋₁ and \hat{x}ₖ represent the posterior state estimates at time k−1 and time k; \hat{x}_{k̅} represents the prior state estimate at time k; Pₖ₋₁ and Pₖ represent posterior estimation covariance at tine k−1 and k, respectively; A^{T} represents the matrix after A transpose, and Q represents the covariance of the excitation noise.

The status update equation is as follows:

$${K}_{k} = \frac{{P}_{\overline{k}} {H}^{T}}{H {P}_{\overline{k}} {H}^{T} + R} ;$$

$${\hat{x}}_{k} = {\hat{x}}_{\overline{k}} + {K}_{k} ( {z}_{k} - H {\hat{x}}_{\overline{k}} ) ;$$

$${P}_{k} = ( I - {K}_{k} H ) {P}_{\overline{k}} ;$$

where the filter gain is represented as Kₖ, H represents the transformation matrix from state variables to the measurements (observations), H^{T} represents the matrix after H transposition, R represents the covariance of the observation noise, and I is the unit matrix.

Because the linear system shown in the above state estimation formula is only theoretically valid, state estimation in practical applications is often not a linear system, and filtering using this method can result in significant errors. Therefore, this embodiment requires correcting this error. To do this, it is first necessary to obtain the parameters that affect the Kalman filter estimation error, namely, the optimal gain estimated by the Kalman filter in this embodiment for wind compensation of a large-aperture reflector antenna.

In a specific implementation, the optimal gain for wind disturbance compensation of a large-aperture reflector antenna estimated by the Kalman filter specifically includes the difference between the Kalman filter's predicted and estimated state values for the large-aperture reflector antenna \hat{x}ₖ−\hat{x}ₖ, the difference between the observed and estimated observed values zₓ−H\hat{x}_{k̅}, and the filter gain Kₖ. The Kalman filter further estimates the optimal gain for wind disturbance compensation of the large-aperture reflector antenna using the following data: the large-aperture reflector antenna's speed output command, current azimuth angle, elevation angle, antenna pointing deviation, equivalent force area, and the wind speed, direction, temperature, humidity, and air pressure of the large-aperture reflector antenna's environment. These data constitute the Kalman filter's input (i.e. the large-aperture reflector antenna's state parameters).

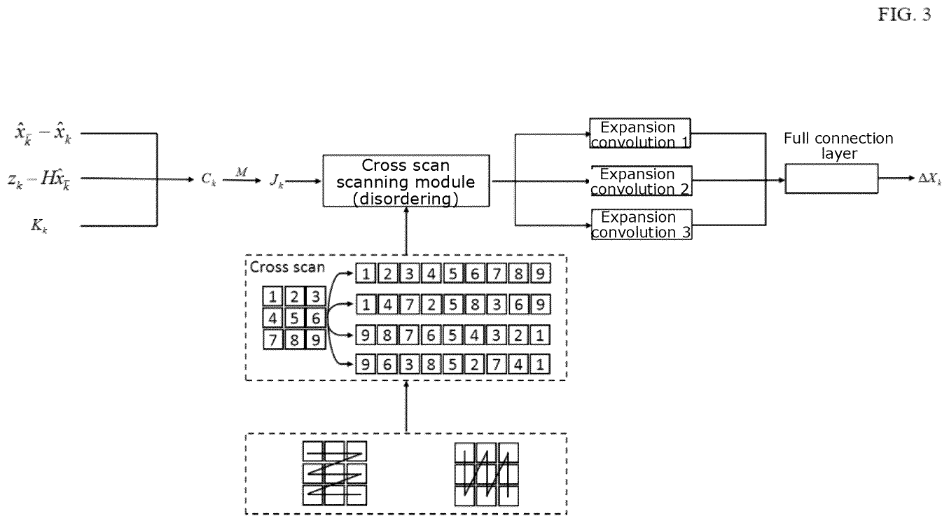

In steps 202 and 203, the network structure used by the error prediction model described in this embodiment is based on a classic three-layer fully connected neural network, combined with the concepts of local receptive field and shared weights of a convolutional network. The network structure used by the error prediction model can be seen in FIG. 3. The error prediction model mainly includes three parts: the first part is a data conversion module, which is used to flatten the control parameters into a one-dimensional vector and then convert it into a two-dimensional matrix; the second part is a cross scan module, which is used to scan from different directions of the two-dimensional matrix to explore the correlation features between adjacent elements in different directions of the two-dimensional matrix; and the third part is a dilated convolution module, which is used to explore the correlation features between non-adjacent elements in different directions of the two-dimensional matrix.

Regarding the data conversion module, for each model data (i.e., optimal gain), if the optimal gain is multi-dimensional, the module first extracts the feature information of each dimension of the optimal gain according to the order of multiple dimensions, and then stores all the feature information in a one-dimensional vector to flatten the control parameters into a one-dimensional vector. Finally, the one-dimensional vector is projected into a two-dimensional matrix through a preset projection matrix.

In the specific implementation, before projecting a one-dimensional vector into a two-dimensional matrix using a preset projection matrix, the features of each dimension in the one-dimensional vector must first be normalized so that the values of the features of each dimension in the normalized one-dimensional vector are all in [0,1]. To complete the vector normalization operation, various features N at each moment are batch collected. For each feature xᵢ and j, categories xᵢⱼ are batch collected and normalized for each dimension of each feature type N. For each xᵢⱼ, the maximum

$${x}_{ij}^{max}$$

and minimum

$${x}_{ij}^{min}$$

values at all moments are counted and normalized

$${x}_{ij} = \frac{{x}_{ij} - {x}_{ij}^{min}}{{x}_{ij}^{max} - {x}_{ij}^{min}} .$$

In subsequent new sample operations, if any values appear out of range

$$[ {x}_{ij}^{min} , {x}_{ij}^{max} ] ,$$

they are first constrained to within the range

$${x}_{ij} = \{ \begin{matrix}{x}_{ij}^{min} , & {x}_{ij} < {x}_{ij}^{min} \\ {x}_{ij}^{max} , & {x}_{ij} > {x}_{ij}^{max}\end{matrix}$$

and then normalized.

Through the above operations, the error prediction model converts the three input quantities (i.e., control parameters) into one-dimensional vectors and concatenates them to form a single input vector Cₖ=[\hat{X}_{k,k-1}−\hat{Z}ₖ,Zₖ−Hₖ\hat{X}_{k,k-1},Kₖ], which is then mapped to a two-dimensional matrix Jₖ=CₖM using a preset projection matrix M. M's function of is to project the one-dimensional vector into a two-dimensional matrix, facilitating subsequent convolutional model operations. Because the relationship between Cₖ and Jₖ cannot be directly described, the parameter M here requires training with a large number of samples. Here, M as part of this model, is learned along with the parameters of subsequent modules through training. The size of M is determined by the dimensions of Cₖ and Jₖ, and the elements in its matrix, like other parameters in the network, are determined during training. In other words, the mapping described here is achieved by flattening the previous output to form a vector and then constructing a linear mapping relationship Jₖ.

Regarding the cross scan module, it specifically scans the two-dimensional matrix horizontally, vertically, inversely horizontally, and inversely vertically. During the horizontal, vertical, inverse-horizontal, and inverse-vertical scanning process, the adjacent elements in the two-dimensional matrix are reordered to extract the association relationship between each element in the two-dimensional matrix and the adjacent elements in different directions, thereby obtaining the association characteristics between adjacent elements in different directions of the two-dimensional matrix. Unlike the indifferent convolution operation of conventional convolution within the local receptive field, the approach is to simultaneously weight the elements in all rows and columns in the region and sum them, where the weights are the values of the convolution kernel matrix.

By introducing a new convolution operator, the cross scan module, and fusing features in different directions, we can reduce the computational complexity of a single scan and use scanning in different directions to explore the correlation between adjacent information in different directions. The reason for using scanning in different directions to fuse features is that the projected matrix Jₖ may contain special correlations between the feature information, which may be connected in different directions. Using the cross scan module can better mine relevant information and extract more valuable features. At the same time, the single-direction scanning method of the cross scan module can improve computational efficiency compared to traditional convolution operations.

Regarding the dilated convolution module, it is specifically composed of dilated convolution operators of different scales. In the process of the cross scan module performing horizontal, vertical, reverse horizontal and reverse vertical scanning on the two-dimensional matrix, the dilated convolution operators of different scales in the dilated convolution module are used to increase the step spacing of the cross scan module, so as to extract the correlation relationship between each element in the two-dimensional matrix and non-adjacent elements in different directions, and obtain the correlation features between non-adjacent elements in different directions of the two-dimensional matrix.

Since the cross scan module operates after reordering adjacent elements in different directions, the relationship between non-adjacent positions is not fully explored. Therefore, this embodiment adds dilated convolution modules of different scales at this position to achieve feature fusion between non-adjacent elements by increasing the step size of the operator operation during the feature fusion process.

Based on the above, the network structure used in the error prediction model of this embodiment is based on a convolutional neural network. The convolution operator is a basic operator in a convolutional neural network, and the convolution kernel is the matrix value within the sliding box (matrix form) during the convolution operation. Convolutional neural networks achieve local perception through local connections, significantly reducing the number of parameters to be trained, lowering the difficulty of network training. Weight sharing further reduces the number of parameters to be trained while maintaining the same computational complexity. Traditional convolutional structures operate on all points in the neighborhood for each pixel location. However, the cross scan module performs each operation in a single direction, resulting in higher efficiency and the ability to freely combine specific directions as needed. The difference between dilated convolution and traditional convolution is that it can perform feature fusion at pixel locations processed by discrete receptive fields, increasing the receptive field range without increasing the complexity of the convolution operation. Therefore, this model can perform multiple error correlations on information of different dimensions, thereby mining potential relationships between information of different dimensions, further enhancing the processing capabilities of the network model.

In step 204, the error prediction model in the above steps also includes a fully connected layer in actual implementation. The fully connected layer of the error prediction model can output the correction amount corresponding to the optimal gain (i.e., the model input data) based on the correlation characteristics between adjacent elements in different directions of the two-dimensional matrix and the correlation characteristics between non-adjacent elements. Then, in this step, when optimizing the optimal gain output by the Kalman filter through the correlation characteristics between adjacent elements in different directions of the two-dimensional matrix and the correlation characteristics between non-adjacent elements, the correction amount output by the error prediction model is specifically added to the optimal gain to obtain the optimized optimal gain.

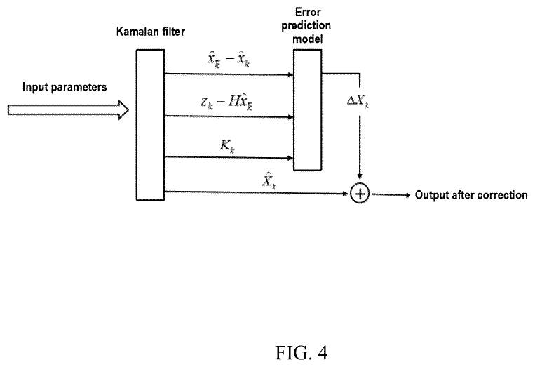

As shown in FIG. 4, the input parameters are the state parameters of the large-aperture reflector antenna. The Kalman filter outputs the optimal gain based on these parameters, which is used as the input to the error prediction model. The output of the error prediction model is ΔXₖ=D−\hat{X}ₖ, where D is the theoretical value of the target state vector. After the model is trained, the model output ΔXₖ (i.e., the correction corresponding to the optimal gain) \hat{X}ₖ is added to the result obtained through Kalman filtering to obtain the optimized optimal gain.

In some embodiments, the above-mentioned error prediction model is specifically trained through the following strategy: first, the optimal gain obtained by the Kalman filter is obtained as sample data, then Gaussian noise is added to the sample data, and the error prediction model is trained using the sample data with added noise, and during the training process, the intensity of the Gaussian noise is gradually increased to train the error prediction model using sample data with different noise intensities.

Since the collected data related to wind disturbance intensity, control torque, etc. all contain certain errors, using such data as training samples M will inevitably have a certain impact on the training of network parameters (the mapping matrix and the parameters of the three dilated convolution modules). Moreover, factors such as wind force in the environment where large antennas are located are changeable, and their direction and strength have no fixed pattern. Therefore, it is difficult to reasonably analyze and predict external disturbance factors such as wind force. Therefore, the adaptability of the network model to disturbances plays a great role in the network's predictive ability. This embodiment uses the idea of diffusion model to actively add noise and reverse learning to the network model training to improve its anti-interference performance, thereby improving the network's prediction accuracy in complex scenarios.

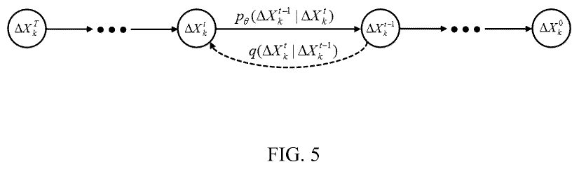

FIG. 5 shows a schematic diagram of the denoising process based on the diffusion model. During training, Gaussian noise is gradually added to the sample features

$$q ( Δ {X}_{k}^{t} \vert Δ {X}_{k}^{t - 1} )$$

through a fixed forward diffusion process until pure noise is obtained. Using the result of a backward denoising diffusion process,

$${p}_{θ} ( Δ {X}_{k}^{t - 1} \vert Δ {X}_{k}^{t} ) ,$$

a neural network is then trained, starting with pure noise and gradually denoising it until a true image ΔXₖ is obtained. The number of forward and backward steps is defined by subscripts, and the total number t of steps is predefined T.

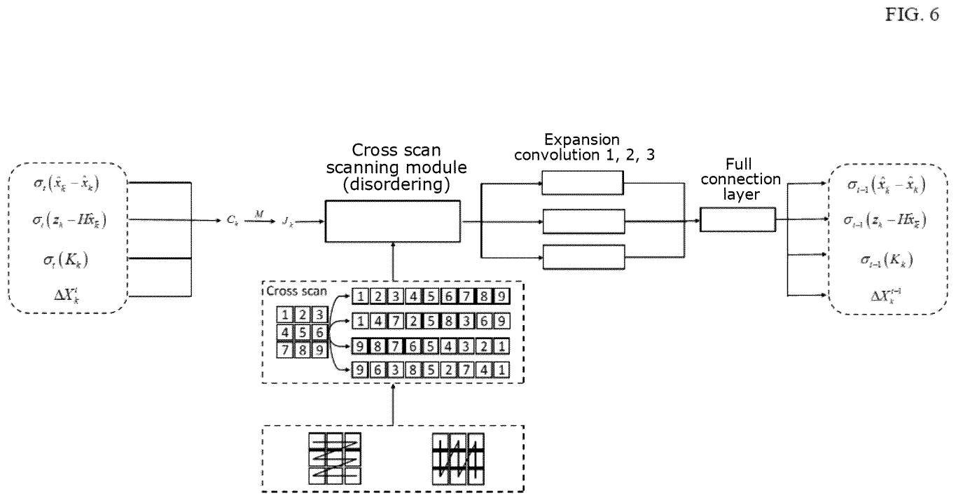

However, given the differences between the error prediction model shown in FIG. 3 and the generative problem, the diffusion model cannot be directly used to improve training results. Therefore, when using the diffusion model, FIG. 3 is optimized, and the structure is shown in FIG. 6. The three inputs (i.e., control parameters) and one output (i.e., the output of the error prediction model) are treated as a whole, and a unified noise addition and reverse denoising process based on the diffusion model is performed. The process used is still to gradually add Gaussian noise to the image through a fixed forward diffusion process

$$q ( Δ {X}_{k}^{t} \vert Δ {X}_{k}^{t - 1} )$$

until pure noise is finally obtained. The error prediction model in FIG. 6 is then used as a trainable method to gradually denoise the pure noise

$${p}_{θ} ( Δ {X}_{k}^{t - 1} \vert Δ {X}_{k}^{t} )$$

until a true four components are obtained. Through active noise addition training, the error prediction model can be improved to improve the disturbance caused by noise in different parameters, and the network's anti-disturbance ability can be improved. It can be seen that this embodiment further optimizes the structure in FIG. 3 through the new structure of FIG. 6, transforming the prediction and estimation process into a cyclic, iterative generative process.

In step 205, after the optimized optimal gain is obtained, wind disturbance compensation is performed on the large-aperture reflector antenna, thereby achieving more accurate antenna pointing.

The steps of the various methods above are divided only for the purpose of clear description. When implemented, they can be combined into one step or some steps can be split and decomposed into multiple steps. As long as they include the same logical relationship, they are within the scope of protection of the present invention. Adding insignificant modifications or introducing insignificant designs to the algorithm or process without changing the core design of the algorithm and process are all within the scope of protection of the invention.

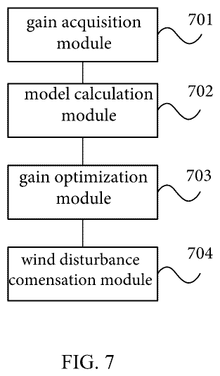

Another embodiment of the present invention relates to a wind disturbance compensation control system for a large-aperture reflector antenna. The implementation details of the wind disturbance compensation control system for the large-aperture reflector antenna of this embodiment are described in detail below. The following content is only for the convenience of understanding the implementation details and is not necessary for the implementation of this solution. The schematic diagram of the wind disturbance compensation control system for the large-aperture reflector antenna of this embodiment can be shown in FIG. 7, including: a gain acquisition module 701, a model solution module 702, a gain optimization module 703 and a wind disturbance compensation module 704.

Specifically, the gain acquisition module 701 is used to input the state parameters of the large-aperture reflector antenna into the Kalman filter, perform state estimation on the large-aperture reflector antenna through the Kalman filter, and obtain the optimal gain for wind disturbance compensation of the large-aperture reflector antenna.

A model solving module 702 is used to input the optimal gain into the trained error prediction model, wherein the error prediction model includes a data conversion module, a cross scan module, and a dilated convolution module;

The feature information in the optimal gain is extracted through the data conversion module, stored in a one-dimensional vector, and converted into a two-dimensional matrix through a preset projection matrix; the correlation features between adjacent elements in different directions of the two-dimensional matrix are mined through the cross scan module, and the correlation features between non-adjacent elements in different directions of the two-dimensional matrix are mined through the expansion convolution module.

gain optimization module 703 is used to optimize the optimal gain obtained by the Kalman filter by using the correlation features between adjacent elements in different directions of the two-dimensional matrix and the correlation features between non-adjacent elements.

on the large-aperture reflector antenna using the optimized optimal gain.

It is not difficult to find that this embodiment is a system embodiment corresponding to the above-mentioned method embodiment, and this embodiment can be implemented in conjunction with the above-mentioned method embodiment. The relevant technical details and technical effects mentioned in the above-mentioned embodiment are still valid in this embodiment, and to reduce repetition, they are not repeated here. Accordingly, the relevant technical details mentioned in this embodiment can also be applied to the above-mentioned embodiment.

It is worth noting that all modules involved in this embodiment are logical modules. In actual applications, a logical unit can be a physical unit, a part of a physical unit, or a combination of multiple physical units. In addition, to highlight the innovations of the present invention, this embodiment does not include units that are not closely related to solving the technical problems proposed by the present invention. However, this does not mean that other units do not exist in this embodiment.

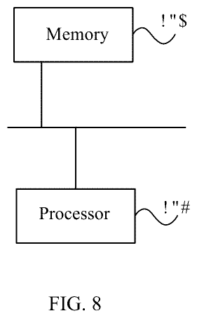

Another embodiment of the present invention relates to a computer device, as shown in FIG. 8, comprising: at least one processor 801; and a memory 802 communicatively connected to the at least one processor 801; wherein the memory 802 stores instructions that can be executed by the at least one processor 801, and the instructions are executed by the at least one processor 801 to enable the at least one processor 801 to execute the large-aperture reflector antenna wind disturbance compensation control method in the above-mentioned embodiments.

The memory and processor are connected using a bus, which can include any number of interconnected buses and bridges. The bus connects various circuits of one or more processors and memories. The bus can also connect various other circuits such as peripheral devices, voltage regulators, and power management circuits. These are all well known in the art and are therefore not described further herein. The bus interface provides an interface between the bus and the transceiver. The transceiver can be a single component or multiple components, such as multiple receivers and transmitters, providing a unit for communicating with various other devices over a transmission medium. Data processed by the processor is transmitted over a wireless medium via an antenna. Furthermore, the antenna receives data and transmits it to the processor.

The processor is responsible for managing the bus and general processing, and can also provide various functions, including timing, peripheral interfaces, voltage regulation, power management, and other control functions. Memory can be used to store data used by the processor when performing operations.

Another embodiment of the present invention relates to a computer-readable storage medium storing a computer program, which implements the above method embodiment when executed by a processor.

That is, those skilled in the art will understand that all or part of the steps in the above-described method embodiments can be implemented by instructing the relevant hardware through a program. The program is stored in a storage medium and includes a number of instructions for causing a device (such as a microcontroller or chip) or a processor to execute all or part of the steps in the method embodiments of the present invention. The aforementioned storage medium includes various media capable of storing program code, such as a USB flash drive, a mobile hard drive, a read-only memory (ROM), a random access memory (RAM), a magnetic disk, or an optical disk.

Those skilled in the art will appreciate that the above embodiments are specific embodiments for implementing the present invention, and that in actual applications, various changes may be made thereto in form and detail without departing from the spirit and scope of the present invention.

What is claimed is:

1. A large-diameter reflector antenna wind disturbance compensation control method, comprising:
inputting state parameters of a large-diameter reflector antenna into a Kalman filter, wherein state estimation of the large-diameter reflector antenna is performed through the Kalman filter to obtain an optimal gain for wind disturbance compensation for the large-diameter reflector antenna;
wherein, the optimal gain is input into a trained error prediction model, wherein the error prediction model comprises a data conversion module, a cross scan scanning module and an expansion convolution module;
wherein feature information in the optimal gain is extracted by the data conversion module, the feature information is stored in a one-dimensional vector, and the one-dimensional vector is converted into a two-dimensional matrix through a preset projection matrix;
wherein correlation features between adjacent elements in different directions of the two-dimensional matrix are mined by a cross scan module, and the correlation features between non-adjacent elements in different directions of the two-dimensional matrix are mined by an expansion convolution module;
wherein the optimal gain obtained by the Kalman filter is optimized by the correlation features between adjacent elements in different directions of the two-dimensional matrix and the correlation features between non-adjacent elements to produce an optimized optimal gain;
wherein the optimized optimal gain is used to compensate for wind disturbance of the large-diameter reflector antenna.

2. The large-diameter reflector antenna wind disturbance compensation control method according to claim 1, wherein association features between adjacent elements in different directions of the two-dimensional matrix are mined by a cross scan scanning module, wherein:
the cross scan module is used to scan the two-dimensional matrix in lateral, vertical, anti-transverse and anti-vertical directions, and a correlation relationship between each element in the two-dimensional matrix and the adjacent elements in different directions is extracted in the process of horizontal, vertical, anti-transverse and anti-vertical scanning, and the correlation characteristics between adjacent elements in different directions of the two-dimensional matrix are obtained.

3. The large-diameter reflector antenna wind disturbance compensation control method according to claim 1, wherein the expansion convolution module is composed of expansion convolution operators of different scales, and the correlation characteristics between non-adjacent elements in different directions of the two-dimensional matrix are mined through the expansion convolution module, wherein:
a step spacing of the expansion convolution module scanning is increased by the expansion convolution operators of different scales in the expansion convolution module to extract a correlation relationship between each element in the two-dimensional matrix and disadjacent elements in different directions, and the correlation characteristics between the disadjacent elements in different directions of the two-dimensional matrix are obtained.

4. The large-diameter reflector antenna wind disturbance compensation control method according to claim 1, wherein the error prediction model also includes a fully connected layer, the association features between adjacent elements in different directions and the correlation features between non-adjacent elements through a two-dimensional matrix are mined, and the optimal gain output of the Kalman filter is optimized, wherein:
the fully connected layer outputs the correction amount corresponding to the optimal gain according to the correlation features between adjacent elements and non-adjacent elements in different directions of the two-dimensional matrix; and
the correction amount output by the error prediction model is added to the optimal gain to obtain the optimized optimal gain.

5. The large-diameter reflector antenna wind disturbance compensation control method according to claim 1, wherein the error prediction model is trained by the following means:
the optimal gain obtained by the Kalman filter is obtained as the sample data;
Gaussian noise is added to the sample data, and the error prediction model is trained using the sample data after adding noise, wherein the intensity of Gaussian noise is gradually increased during the training process, so as to train the error prediction model with sample data with different noise intensities.

6. The large-diameter reflector antenna wind disturbance compensation control method according to claim 1, wherein the state parameters of the large-diameter reflector antenna comprise:
a speed output command, current azimuth angle, pitch angle, antenna pointing deviation, equivalent force area, wind speed, wind direction, temperature, humidity, and air pressure of the environment in which the large-diameter reflector antenna is located.

7. The large-diameter reflector antenna wind disturbance compensation control method according to claim 6, wherein the optimal gain comprises a difference between a predicted state value and an estimated state value of the large-diameter reflector antenna of the Kalman filter, the difference between an observed value and an estimated observation value, and a filter gain.

8. A large-diameter reflective antenna wind disturbance compensation control system, wherein:
a gain acquisition module is used to input state parameters of a large-diameter reflector antenna into a Kalman filter, and a state estimation of the large-diameter reflector antenna is performed through the Kalman filter to obtain an optimal gain for wind disturbance compensation for the large-diameter reflector antenna;
a model solving module, which is used to input the optimal gain into the trained error prediction model, and an error prediction model comprising a data conversion module, a cross scan scanning module and an expansion convolution module;
wherein feature information in the optimal gain is extracted by the data conversion module, the feature information is stored in a one-dimensional vector, and the one-dimensional vector is converted into a two-dimensional matrix through the preset projection matrix; wherein correlation features between adjacent elements in different directions of the two-dimensional matrix are mined by the cross scan module, and correlation features between non-adjacent elements in different directions of the two-dimensional matrix are mined by the expansion convolution module;
a gain optimization module, which is used to optimize the optimal gain obtained by Kalman filter through association features between adjacent elements and non-adjacent elements in different directions of the two-dimensional matrix;
a wind disturbance compensation module configured to compensate for wind disturbance of large-diameter reflector antennas using the optimized optimal gain.

9. A computer device comprising at least one processor; and, a memory connected to at least one processor; wherein, the memory stores instructions that can be executed by at least one processor, and the instructions are executed by at least one processor, so that at least one processor can execute the wind disturbance compensation control method of the large-diameter reflective surface antenna as described in claim 1.

10. A computer-readable storage medium with a computer program stored, wherein when the computer program is executed by a processor, the wind disturbance compensation control method for the large-diameter reflective surface antenna is realized as described in claim 1.
